(19) United States
(12) Patent Application Publication
(10) Pub. No.: US 2009/0203247 A1
(43) Pub. Date: Aug. 13, 2009

(54) QUICK-CONNECT SPLICE-FREE CAR CONTROLLER

(76) Inventors: Jacob Walt Fifelski, Wayland, MI (US); Vernon Andrew Bellgraph, Hopkins, MI (US)

Correspondence Address: Fifel-Graph Innovative Technologies Inc, 1710 138th Avenue, Wayland, MI, 49348-9561, US

(21) Appl. No.: 12/369,739

(22) Filed: Feb. 11, 2009

Related U.S. Application Data
(60) Provisional application No. 61/027,816, filed on Feb. 11, 2008.

(51) Int. Cl. H01R 13/62

(52) U.S. Cl. 439/345

(57) ABSTRACT

The quick-connect splice-free connector establishes a connection between controller 5 with wires terminating at the OBD-II J192 female connector within the car where the pin-out locations are standardized regarding the pins electrical polarity and function, selected from the group of predetermined pin locations providing battery voltage, chassis ground, signal ground, J1850 Bus+, CAN High J-2284, ISO 9141-2 K Line, CAN LOW J-2284, and ISO 9141-2 L Line, and in accordance to these pin-outs, chassis ground pin 4 and battery voltage pin 16 are shown on FIG. 1. The quick-connect splice free connector offers many advantages to the lay person in that a professional installer is not required and all vital electrical signaling lines are readily available through the connector, thus eliminating human error, automobile computer system damage, and complexities of the install by providing controller 5 with direct and safe access to all signaling paths.

### CROSS-REFERENCE TO RELATED APPLICAIONS

This application claims priority under 35 U.S.C. .sctn.119(e) of U.S. provisional patent application Ser. No. 61/027,816, filed 2008 Feb. 11 by the present inventor.

### FEDERALLY SPONSORED RESEARCH

Not Applicable

### SEQUENCE LISTING OR PROGRAM

Not Applicable

### BACKGROUND

1. Field of Invention

This invention relates to automotive electrical systems, specifically how the electrical and computer systems can be controlled through the on-board diagnostics-II, OBD-II, standardized J1962 female connector where a quick-connect splice-free connector and controller can be easily connected and connection retained for communicating through the five protocols used with the OBD-II interface to remotely control motor vehicles eliminating the need to physically and manually splice wires within an automobile to integrate controller.

2. Prior Art

Controllers, namely remote control of vehicles dates back to a time where users first remotely started their vehicles with wires from afar to warm the engine before the occupant entered the vehicle as described in Phairr U.S. Pat. No. 4,392,059. As technology advanced, the technology became wireless and users could remotely start and control a vehicle through radio frequency technology transmitted by a handheld transmitter. Even now technology has advanced to such a point where users can connect to their vehicles and control various aspects with their computers, cell phones and other means from unlimited distances. Devices include remote starters, car alarms, telemetry devices, GPS, vehicle locators, etc. Although incredibly popular and convenient, the installation of such devices is far from convenient, requires expertise installers, and is time consuming. All of these devices have a controller which integrates with the vehicle through many connections in order to provide a desired result. With vehicle electrical systems becoming more advanced the task of integration has become dangerous and jeopardizes the vehicles computer system.

Installation of these controllers requires many wires to be spliced and exposed. The removal of the factory wire insulation by the installer to install the electrical equipment causes irreversible damage. Corrosion will take place with the wire being exposed to the elements. If any moisture is present in the vehicle, the moisture will collect near the splice. Corrosion will lead to poor electrical conductivity which will increase the resistance of the wire, which ultimately will affect voltage and amperage travel in the wire which will indefinitely lead to circuit failure or even electrical fire. The vehicle environment is prone to moisture, especially where these vehicle electronics such as GPS, remote starters and telemetry products are located and installed-under the dash by the foot pedals, which day in and day out collect moisture from the users' footwear on days with precipitation—snow or rain.

Splices for these hard connections are covered with electrical tape. With time, this tape can work loose, the installer can put an inadequate amount of tape on the splice, or may neglect to put any electrical tape on the splice, all of which expose the bare wire which could lead to an electrical short. Such a short could also lead to fire and serious damage. Aside from the conductivity shortcomings of manual spices, comes the variable of human error. Wires must be properly identified, insulation removed, and then taped. Vehicles vary by make and model and even by year which creates confusion and also complicates the installation process. Great expertise is needed as well as database resources. Any improper information could lead to the wrong wire being spiced which again could result in vehicle systems failure, fire, property damage and even death. A typical remote car starter consists of approximately 20 connections and takes a professional installer 2-4 hours to install. Complicate matters with telemetry features, GPS, vehicle locators, etc and the installation time increases. All of these variables lead to an incredibly inefficient method of outfitting a vehicle with a control device of any sort.

Proper vehicle functioning also relies on the aftermarket hardware and software being installed. If there is a failure with any of the installed electrical components, the vehicle may not start or operate properly. Typical remote starters bypass modules, telemetry units, and GPS devices contain many transistors, relays, and switches, etc to manually switch or bypass features. In Flick 7224083 an invention is described as: The remote start control system may include at least one device associated with starting an engine of the vehicle, a remote start transmitter, and a vehicle remote start controller connected to the data communications bus for communicating with the at least one vehicle devices associated with starting the engine of the vehicle. The remote start controller may be responsive to signals from the remote start transmitter. Flick has a noticeable improvement on the overall design of the remote car starter or controller with direct connection to the vehicle data bus, as it eliminates the manual switching and control of various components within the vehicle and instead communicates with the vehicle computer and has the vehicle computer execute. This reduces the number of splice points and mechanical failure of the system but still requires hard splicing. Hard splicing the data wires or computer wires on a vehicle can be dangerous as they are sensitive to electrical voltage. Sending improper signals or a slightly improper resistance value along this data line could result in “frying” or destroying the vehicle computer. Accidentally grounding your wire cutters, knife, or other install tool while making contact with the data wire could result in a terrific loss.

Nevertheless all vehicle controllers including remote starters, telemetry devices, GPS, and vehicle tracking equipment suffer from these disadvantages:

a) Their complicated design requires expertise installation and educated installers.

b) Installation is time consuming

c) Installation and integration requires hard splicing of wires

d) Human error during the installation process

e) Design of the device consists of many working components prone to failure, components that tax the electrical capabilities of the vehicle electrical system and alter the electrical paths of the signals themselves, which the vehicle was not engineered to support

f) Need for additional equipment to “bypass” vehicle features as a “makeshift” way of “fooling” the vehicle into working properly.

g) Inability to communicate with the vehicle computer system directly

Despite these pitfalls, remote car starters and alarms continue to sell in the millions each year, and new exciting technologies are on the horizon all of which could benefit from a quicker, more efficient and universal method of installation that could eliminate any hard splices, wire identification, and reduce the amount of hardware components. Ideally a universal connector could be employed or leveraged to eliminate wire splices, and provide universal connectivity to all vital wires in the vehicle electrical system including but not limited to battery voltage, ground, and signal ground and to the connection to the vehicle computer system.

Starting in 1996 the united states set forth specifications for monitoring and reporting engine performance in modern automobiles, and was called On-board diagnostics, OBD-II. The OBD-II specification provides for a standardized hardware interface with a female 16-pin (2×8) J1962 connector which is usually located on the driver's side of the passenger compartment near the center console. For the sake of simplicity we will refer to this as simply the OBD-II J1962 connector, and is female, but female will not be accompany this term each time it is referenced. There are five protocols in use with the OBD-II. Predetermined pin locations make for a uniform install with safe access to control and communicate with the vehicle computer, without the need to manufacture and try to make another universal connector.

The claimed invention leverages from the universal aspects of the OBD-II connector and standardized pin-out locations. A controller is linked with a OBD-II J1962 male connector where the connector mates with the ever popular OBD-II female connector found within vehicle and invention in a preferred embodiment utilizes a pass-through style OBD-II J1962 connector with a male end and a female end with an alternative locking mechanism. To date it is important to reference that the OBD-II J1962 connector has primarily been used to access vehicle data with diagnostic scan tools and is intended for short term connection. Invention establishes a connection at the OBD-II J1962 female connector with vital lines of communication with said invention controller. Quick-connect splice-free connector also retains a more permanent connection to control and communicate various functioning while the pass-through arrangement on the connector still grants access to the OBD-II connector for servicing.

The connector is advantageous in that it reduces installation effort saving time and also reduces human error and electrical shortcomings associated with making hard connections via splicing wires and tying in directly. Connector promotes clean, safe installation, with easy removal, as well as a means to securely retain connection, all the while allowing access to the OBD-II port for diagnostics and aftermarket accessories and or equipment. OBD-II provides direct access to all major electrical and communication lines of the vehicle in an easily accessible location without the need to create another connection within the vehicle. OBD-II connection on controller allows for a much cleaner and easier install with a plug and play style connection with all wires and connections aligning at the same location rather than going all different directions in the vehicle. OBD-II set protocols also establishes some uniformity which promotes efficiency of installation. Some instances won't even require interior panels to be removed for installation. Wires can exit the connector from one or multiple sides of the connector if required.

### SUMMARY

Device consisting of a controller coupled with a quick-connect splice-free connector that mates to the OBD-II J1962 female connector found within the vehicle to transmit data to vehicle where OBD-II connector provides direct access to vehicles electrical and computer system. Connector leverages from an alternative pass-through design to retain access to vehicle's OBD-II plug. Method of locking and securing quick connect to OBD-II plug.

### DRAWINGS—FIGURES

FIG. 1 shows front head-on view of said quick-connect splice-free connector with controller with male pins being solid black. This male end faces the car and plugs directly into the OBD-II J1962 female connector.

FIG. 2 shows top view of quick-connect splice-free connector with controller.

FIG. 3 shows back view of quick-connect splice-free connector with controller and demonstrates the pass-through design as it replicates the OBD-II J1962 female connector.

FIG. 4 shows a rendered artwork of the OBD-II J1962 female connector commonly found within the vehicle usually on the driver side.

### DRAWINGS—REFERENCE NUMERALS

1 pin number one

4 chassis ground pin

5 controller

7 retaining clip

8 pin number eight

9 pin number nine

11 wire housing

16 battery voltage pin

### DETAILED DESCRIPTION

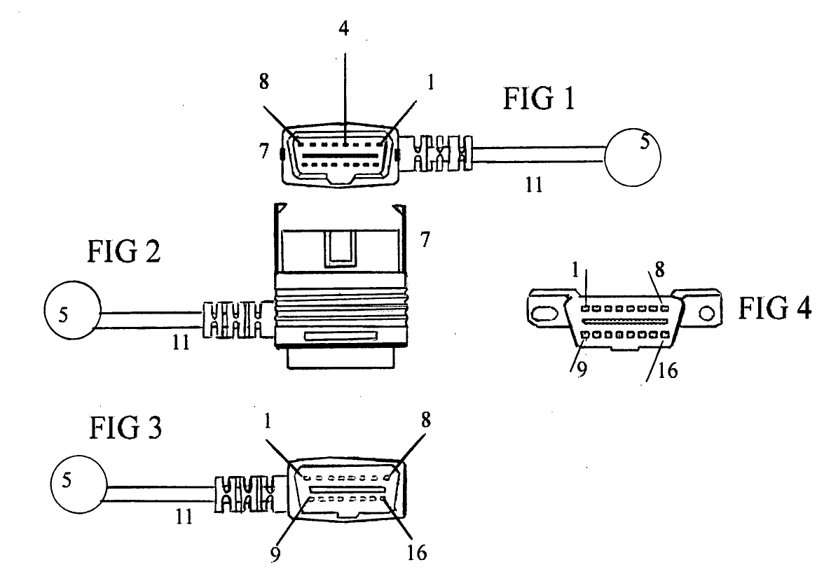

One embodiment of the quick-connector car controller is illustrated in FIG. 1 which is a front view of the connector with controller 5. Pin number one 1 is shown in the upper right of the connector and will define the top of the connector opposed to the bottom of the connector. Pin number one 1 also defines a left from right with pin number one 1 being the left of the connector when inserted into the OBD-II J1962 female connector show in FIG. 4 which is the view one would witness if looking directly at the OBD-II J1962 female connector installed within the vehicle from the factory. Retaining clip 7 is located on either side of the quick-connector and extend away from the quick-connector to retain connection with OBD-II J1962 connector by reaching around backside of OBD-II J1962 female connector located in the car and forming a grip behind the backside of the connector to prevent dislocation between quick-connect and OBD-II J1962 female connector, in an alternative embodiment influenced by vehicle make and model, retaining clip 7 could be located on top or bottom of J1962 connector. Wire housing 11 provides protection to the wires that connect controller 5 with quick-connect splice-free connector.

To install quick-connect splice-free connector, the male pins 1-16 on male front side of the connector must be inserted into female end of the OBD-II J1962 connector FIG. 4 located within the vehicle. Steady pressure is require while pushing the pins into the plugs until a clicking noise is heard when the retaining clips 7 slip around the backside of the connector from the lift and right sides. In an alternative, yet equally preferred embodiment variable due to make and model vehicles, the retaining clips 7 position can be altered and located in different areas along the perimeter of the quick-connect splice-free connector, for example along the bottom side shown in FIG. 3 where pin nine 9 and pin sixteen 16 designate the bottom side of the quick connector as opposed to the top side where pin number one 1 and pin number eight 8 are located, where the retaining clip could also be located. The location of the retaining clip 7 and number of retaining clips 7 varies in accordance to the vehicle in which it is being installed per manufacturer standards.

Removal of the quick-connect splice-free connector would require the retaining clips to be disengaged and pressure applied toward the user until quick-connector was free of the OBD-II J1962 female connector.

FIG. 2 shows a top view of the quick connect where retaining clips 7 exit the front of the quick-connect splice-free connector as represented in FIG. 1. Please note that in all drawings, items are not drawn to scale and wire housing 11 length is not depicted. Wire housing 11 can exit the quick-connect splice-free connector from any side and surface, not limited to that depicted in the drawings. In an alternative embodiment the controller 5 could be linked with a wireless protocol opposed to using wire housing 11 or wires, but the quick-connector would still plug into OBD-II J1962 connector and communicate with controller 5 through wireless radio frequency or rf.

The quick-connect splice-free connector establishes a connection between and direct integration of controller 5 with wires terminating at the OBD-II J192 female connector within the car where the pin-out locations are standardized regarding the pins electrical polarity and function, selected from the group of predetermined pin locations providing battery voltage, chassis ground, signal ground, J1850 Bus+, CAN High J-2284, ISO 9141-2 K Line, CAN LOW J-2284, and ISO 9141-2 L Line, and in accordance to these pin-outs, chassis ground pin 4 and battery voltage pin 16 are shown on FIG. 1. The quick-connect splice free connector offers many advantages to the lay person in that a professional installer is not required and all vital electrical signaling lines are readily available through the connector thus eliminating human error, automobile computer system damage, and complexities of the install by providing controller 5 with direct and safe access to all signaling paths.

### Advantages

From the description above, a number of advantages of some of the embodiments on our quick-connect splice-free car controller become evident:
a) Installation of car controllers are now as easy as locating the OBD-II J1962 female connector and slipping the quick-connect car controller onto the receptacle establishing and completing a circuit between said controller and vehicle electrical paths including but not limited to power, ground, and data lines, which terminate and are available at the female OBD-II J1962 connector located conveniently within the vehicle, usually on the drivers side. The Controller Area Network bus, Can bus, is one such data line on which all vehicle computer systems communicate and Quick-Connect Splice-Free Car Controller directly communicates. The vehicle can be controlled by sending messages along or on said communication line or lines. The improvement is apparent with the controller communicating with the vehicles computer network directly to prompt vehicle functioning, digitally rather than analog through the bus itself. Digital communication has little current draw and therefore power can be provided directly from the vehicle's OBD-II diagnostics port which is a J1962 female connector to the controller, along with ground. Therefore Quick-Connect Splice-Free Car Controller is truly a plug and play and requires no other connections, something no other car controller of any sorts, including remote car starters and alarms can boast.
b) No wires need to be located, as Quick-Connect Splice-Free Car Controller would be prewired for vehicle.
c) No wires need to be stripped or tapped
d) Reduced form factor of controller with controller connections all terminating at the same location
e) A pass-through arrangement where the car controller can retain connection without the need to be removed to service the vehicle and other aftermarket devices can be added in addition
f) Locking mechanism helps retain connection as current OBD-II style connectors are intended primarily for short term use i.e. in a shop for diagnostics and repair, whereas car controller with quick-connect splice-free connector is intended for long term usage and needs to stay secure.

What is claimed is:

1. A machine for communicating with and controlling an automobile, comprising of a controller and a quick-connect splice-free connector that plugs into the on-board diagnostics-II (OBD-II) J1962 female standardized connector, also considered a plug or port, commonly found within a automobile, where said connector retains connection with retainer clips.

2. The retainer clips of claim 1 attached to said quick-connect splice-free connector grasp back side of said OBD-II J1962 connector to retain connection between controller with quick-connect splice-free connector and OBD-II J1962 female connector within car.

3. The quick-connect splice-free connector of claim 1 offers pass-through design, consisting of a male end and female end, to allow access to the said automobile OBD-II J1962 female connector allowing repair, diagnostic retrieval by technicians, and connection of other aftermarket devices.

4. The quick-connect splice-free connector of claim 1 has predetermined pin locations specific to those predetermined locations of the said OBD-II J1962 connection with a maximum of 16 pins which can be populated accordingly, wherein the said controller is connected to said quick-connect splice-free connector specific to the predetermined locations based on make and model of vehicle, where the improvement eliminates any wire locating, identification, or stripping by the user or installer, thus creating a true plug-and-play integration process of the controller.

5. The quick-connect splice-free connector of claim 1 establishes a connection to wires terminating at the OBD-II J192 female connector where the pin-out locations are standardized regarding the pins electrical polarity and function, selected from the group of predetermined pin locations providing battery voltage, chassis ground, signal ground, j1850 Bus+, CAN High J-2284, ISO 9141-2 K Line, CAN LOW J-2284, and ISO 9141-2 L Line.

6. The controller of claim 1 is capable of receiving data over radio frequency signal.

7. The controller of claim 1 is capable of receiving and transmitting data over radio frequency over multiple networks.

8. The controller of claim 1 is capable of being mated to an automobile through authentication process.

9. The controller of claim 1 communicates with automobile to determine connection status where if the connection between automobile and controller is lost, wherein the automobile will respond accordingly.

10. The controller of claim 1 can be compatible with multiple automobiles and can be transferred between automobiles.

11. The controller of claim 1 can be updated.

12. A method of communicating with a automobile and controlling an automobile comprising:
a. a controller
i. where controller has radio frequency, rf, capability
b. a connector that mates directly with the OBD-II J1962 female connector
i. where connector offers pass-through design
ii. and connector has retaining clips to lock to OBD-II connector, whereby the automobile's electrical system need not be altered or negatively influenced, and direct access to vehicles computer network is made available without impeding access to OBD-II J1962 female connector and connection is retained.

13. A method of remote starting a vehicle and controlling the vehicle, comprising:
a. Providing a controller with rf capability
b. Providing quick-connect splice-free connector for plugging directly into OBD-II J1962 female connector with pass through design and retaining capability, whereby installing a remote starter could be performed by the lay person and not an expert without the need to identify, locate, and splice automobile wiring.
c. Providing connector that mates with OBD-II J1962 female connector where ground, battery voltage, signal ground and access to vehicle computer system
i. Provided connector provides a means to retain connection with retaining clips and grasping the OBD-II J1962 from back side, whereby the splice free integration is completed and sensitive computer data wires are not subjected to improper electrical signals.
ii. Retain connection through retaining clips, whereby wireless connectivity is easily integrated and ushered into vehicle through the OBD-II port and predetermined pins with the ability to add additional lines and populating more pins in the OBD-II J1962 connector for data transfer and wireless applications
